(19) United States
(12) Patent Application Publication
(10) Pub. No.: US 2023/0359229 A1
(43) Pub. Date: Nov. 9, 2023

(54) DIAPHRAGM SEALED GAS PRESSURE REGULATOR

(71) Applicant: Dye Precision, Inc., San Diego, CA (US)

(72) Inventors: John CHAMBERS, Whitehouse, TX (US); William WING, Auburndale, FL (US)

(21) Appl. No.: 17/736,410

(22) Filed: May 4, 2022

(51) Int. Cl. G05D 16/06; F41B 11/724

(52) U.S. Cl. CPC G05D 16/0663; F41B 11/724

(57) ABSTRACT

The present invention provides a gas regulator with a diaphragm-type seal for a paintball marker or other type of gas-operated device. All regulator components are housed within a base to offer component longevity, easy adjustment of the regulated pressure, and simple maintenance. The diaphragm type seal acts as a sensing element where a seat rides on the interior surface of the diaphragm. Because the seat is positioned inside the diaphragm, a direct path is created to maintain constant pressure and increase accuracy from the seat to a pin valve.

### BACKGROUND OF THE INVENTION

### 1. Field of Invention

The invention relates to a gas pressure regulator to control the flow of a gas from a high-pressure source to a lower pressure device such as a paintball marker at a predetermined outlet pressure.

### 2. Description of Related Art

Paintball markers use compressed gas, such as carbon dioxide, nitrogen, or compressed air stored in a tank to propel paintballs through a barrel. Generally, paintball systems have four main components: the marker, which contains a firing valve, the loader, the barrel, and the tank. The tank holds the compressed gas to propel paintballs through the barrel. All markers require air to be supplied at a certain pressure to launch a paintball at a given velocity from the barrel. Thus, a paintball marker requires a pressure regulator to control the amount of force at which the paintball is propelled.

Generally, a pressure regulator comprises two chambers: a high-pressure inlet chamber and a low-pressure outlet chamber. The regulator operates to close a valve, opened by the marker's firing valve, when the outlet chamber reaches a certain threshold pressure below what is to be provided by the tank. The outlet chamber expands and has a mechanically linked seat or main seal. The seat shuts off airflow and is controlled by an O-ring, sealing poppet, or a plastic/rubber disk. Once the pressure reaches the threshold, the seat isolates regulated gas from the compressed gas supply in the tank. The outlet chamber is fit against a piston, a spring, or a Belleville disk pack to counter the pressure within the outlet chamber. Once the pressure exerted on the piston falls below the force provided by a spring, it is moved to allow gas to flow from the high-pressure chamber to the low-pressure chamber. If the pressure from one chamber equals the spring or piston being pressed down, the piston moves down and creates a seal by closing the valve. The piston's motion isolates the transfer of air from the high-pressure inlet chamber from the outlet chamber at a pressure determined by the pneumatic force exerted on the piston's surface area in the closing direction minus the spring force acting to determine the opening force and thus, the pressure at which the chambers are isolated.

There are two types of regulator designs: the floating poppet and the moving base. The floating poppet uses a flared poppet shaft and spring to push open an air valve. An air pressure sensing element engages the shaft or seat to push away the seat from a sealing surface. The moving base uses a t-shaped piston pressed against the seat to create a seal. However, because of the complexity and intricacies of the mechanical components, these types of regulators tend to wear out quickly, are difficult to maintain, and cannot easily adjust pressures from low to high. Additionally, regulator components block a direct path from the seat to a pin and thus provides inconsistent pressure. When the marker is not regulated with consistent pressure, the velocity of the paintball leaving the barrel is ever-changing, and accuracy and control are degraded over time.

U.S. Pat. Nos. 6,851,447 and 7,059,343 to Carroll disclose a direct acting gas regulator, which has been a de facto standard OEM regulator for numerous paintball marker manufacturers. The direct acting gas regulator utilizes a piston and spring assembly, which is moveable between an open regulator condition and a close regulator condition. Experienced paintball players complain that this regulator is too heavy, oversized, and prone to creep, i.e., the outlet pressure drifts away from its rated pressure over time. Although the Carroll patents are set to enter the public domain in 2023, a need exists for a smaller, lighter, and more dependable regulator.

### SUMMARY OF THE INVENTION

The present invention overcomes these and other deficiencies of the prior art by providing a diaphragm sealed regulator for a paintball marker. All regulator components are housed within a base to offer component longevity, easy adjustment of the regulated pressure, and simple maintenance. In an embodiment of the invention, a diaphragm type seal acts as a sensing element where a seat rides on the interior surface of the diaphragm. Because the seat is positioned inside the diaphragm, a direct path is created to maintain constant pressure and increase accuracy from the seat to a pin valve. In addition to increasing pressure regulation accuracy due to the direct path created from the seat riding the diaphragm, the present invention improves pressure flow. The geometry of the diaphragm is less restrictive and allows more flow area between the seat and the low-pressure chamber than moving base designs.

In an embodiment of the invention, a gas regulator comprises: a base, a gas transfer tower assembly comprising a high-pressure gas passageway having an opening at an end of the gas transfer tower assembly, wherein the gas transfer tower assembly is coupled to the base; a diaphragm comprising a seat and one or more ports, wherein a portion of the diaphragm surrounds the end of the gas transfer tower assembly; and a spring stack, wherein one end of the spring stack is in contact with the gas transfer tower assembly or the base; and an opposite end of the spring stack is in contact with the diaphragm. The end of the gas transfer tower assembly is cylindrically shaped. In a closed regulator position, the seat is in contact with the opening of the passageway. In an open regulator position, the seat is not in contact with the opening of the passageway. The passageway is in fluidic communication with a high-pressure gas source. The seat may be shaped like a ball. The seat is disposed on an interior surface of the diaphragm. The gas regulator further comprises a rotatable bonnet. The gas transfer tower assembly includes a burst disc passageway. The gas regulator may be used in a gas-operated device.

In another embodiment of the invention, a method of regulating gas flow from a high-pressure gas source to a gas-operated device comprises the steps of: contacting a seat, disposed on an inner surface of a diaphragm, to an opening of a high-pressure gas passageway within a gas transfer tower assembly; forcing the seat away from the opening of the highpressure gas passageway; transferring high-pressure gas from the opening of the high-pressure gas passageway to an outlet chamber; and returning the seat in contact with the opening of the high-pressure gas passageway. Transferring high-pressure gas comprises transferring the high-pressure gas through one or more ports within the diaphragm. The step of forcing the seat away from the opening of the high-pressure gas passageway comprises exerting a spring force on the diaphragm. The method may further comprise the step of adjusting the spring force. The method may further comprise the steps of securing a bonnet to the gas-operated device and rotating the bonnet. The high-pressure gas passageway is in fluidic communication with a high-pressure burst disk. The outlet chamber is in fluidic communication with a low-pressure burst disk via a low-pressure passageway within the transfer tower assembly. The transfer tower assembly is fixed to a base, and the step of forcing the seat away from the opening of the high-pressure gas passageway comprises moving the diaphragm relative to the transfer tower assembly. The diaphragm, seat, and transfer tower assembly are contained in the base.

The present invention provides significant benefits compared to floating poppet, moving base, and piston-spring regulators. It is smaller than existing regulators and easy to use, clean, and maintain. The bonnet is rotatable by 360 degrees, allowing the end-user to adjust the orientation of secondary components such as a gauge and fill nipple.

The foregoing and other features and advantages of the invention will be apparent from the following, more particular description of the invention's preferred embodiments, as shown in the accompanying drawings and the claims.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a gas pressure regulator according to an embodiment of the invention.

FIG. 2 illustrates a cross-sectional view of the gas regulator of FIG. 1 in a closed regulator position.

FIG. 3 illustrates an exploded view of the gas regulator of FIG. 1.

FIG. 4 illustrates a cross-sectional view of the gas regulator of FIG. 1 in an open regulator position.

FIG. 5 illustrates gas flow paths for low-pressure and high-pressure burst discs in the gas regulator of FIG. 1.

### DETAILED DESCRIPTION OF PREFERRED EMBODIMENTS

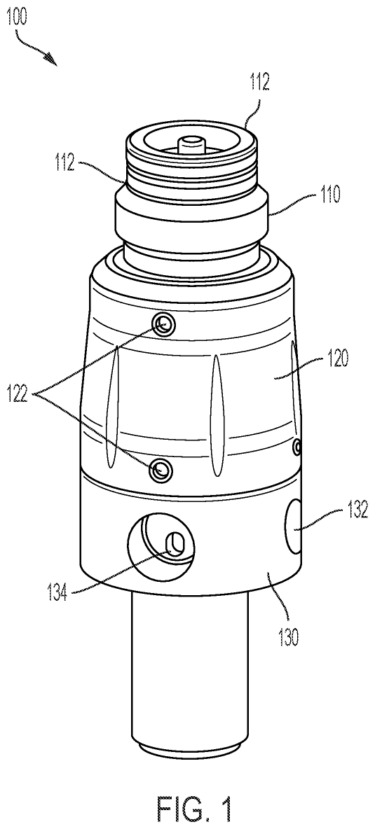

Preferred embodiments of the present invention and their advantages may be understood by referring to FIGS. 1-5. The described features, structures, or characteristics of the invention may be combined in any suitable manner in one or more embodiments. It will be apparent to those skilled in the art that various modifications and variations can be made to the present invention without departing from the invention's spirit and scope. Thus, the current invention is intended to cover modifications and variations consistent with the scope of the appended claims and their equivalents. Although the present invention is described in the context of paintball markers, the invention applies to any type of gas-operated device such as but not limited to a medicine delivery gun, a pepper ball gun, an arrow gun, a slug gun, a BB gun, a pellet gun, and an airsoft gun.

FIG. 1 illustrates a gas pressure regulator 100 according to an embodiment of the invention. The regulator 100 comprises a bonnet 110, a collar 120, and a base 130. The bonnet 110 comprises one or more O-rings 112 so that the bonnet 110 and hence regulator 100 is rotatable 360 degrees relative to a marker (not shown). Such rotation permits a user to change the position of a gauge (not shown) and fill nipple (not shown) to avoid contact with the user's wrist. In an exemplary embodiment of the invention, two O-rings 112 are utilized to ensure a seal of regulated gas flow to a marker. The bonnet 110, the collar 120, and the base 130 are secured to one another via two set screws 122. The base 130 includes ports 132 and 134 for a fill nipple and a tank gauge, the implementation of which is apparent to one of ordinary skill in the art.

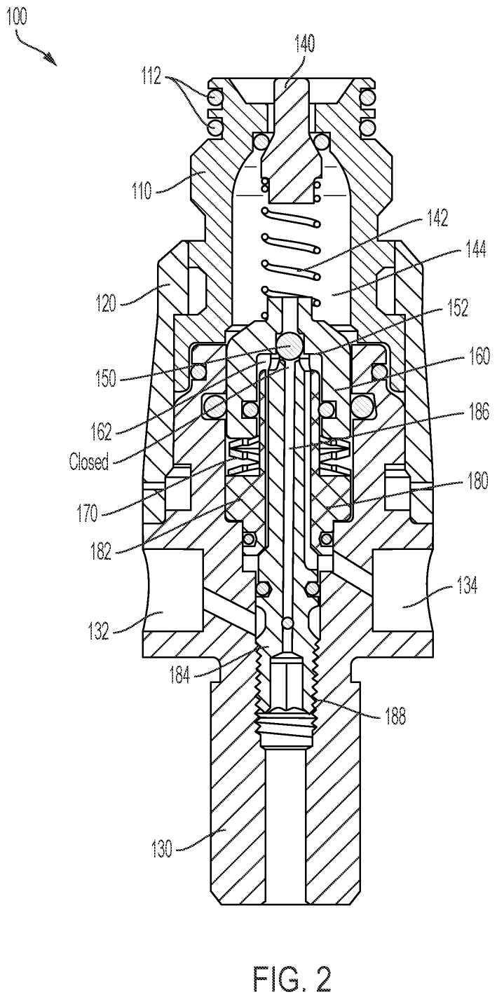

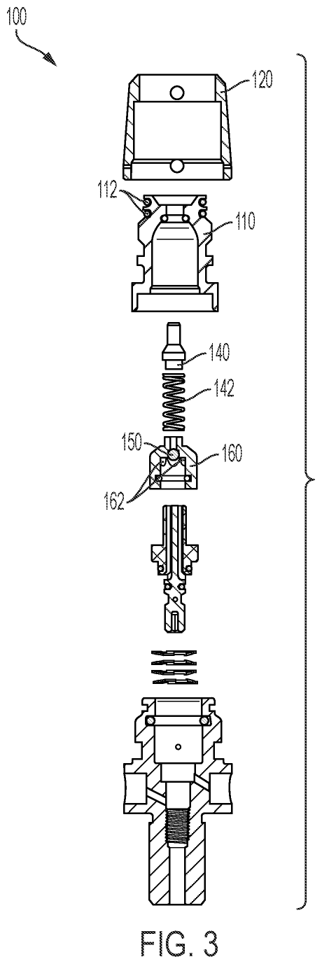

FIG. 2 illustrates a cross-sectional view of the regulator 100 in a closed regulator position to show its inner components. FIG. 3 illustrates an exploded view of the regulator 100. Referring to these figures, enclosed within the bonnet 110 is a pin valve 140 and pin spring 142, maintained within an outlet chamber 144. The spring 142 provides a bias to keep the pin valve 140 closed. The pin valve 140, the implementation of which is apparent to one of ordinary skill in the art, provides a sealable gas flow path from the regulator 100 to the marker. The pin valve 140 also permits separating the regulator 100 from the marker without losing gas pressure.

The regulator 100 also comprises a seat 150, a sensing diaphragm 160, a spring stack 170, and a transfer tower assembly 180. The seat 150 is positioned on an interior surface 152 of the diaphragm 160, with one or more ports 162 to permit gas to pass through to the outer chamber 144. The seat 150 functions as the main regulator seal that isolates regulated air in the outlet chamber 144 from high-pressure gas provided by a tank (not shown) in fluidic communication with and coupled to the port 132. In an exemplary embodiment of the invention, the seat 150 is shaped like a ball and press-fitted into the diaphragm 160. Any shape that can create a proper seal against the tower. However, other shapes may be employed, such as but not limited to a puck, dome, or cone. Suitable materials for the seat include but are not limited to nylon, polyoxymethylene (POM), rubber polyetheretherketone (PEEK), and polytetrafluoroethylene (PTFE). Because the seat 150 is positioned on the interior surface 152 of the diaphragm 160, the diaphragm 160 acts as a sensing element to regulate gas from the tank to the outlet chamber 144. The diaphragm 160 eliminates the need for a piston as in the Carroll patents because the seat 150, which forms the regulator seal, is positioned between the outlet chamber 144 and the transfer tower assembly 180.

The transfer tower assembly 180 comprises an outer component 182 and an inner component 184 that are press-fit together in this embodiment. Within and along the cylindrical axis of the inner component 184 is a gas transfer passageway 186 in fluidic communication with the high-pressure tank coupled to the port 132. The transfer tower assembly 180 is fixed within the base 130 via threads 188.

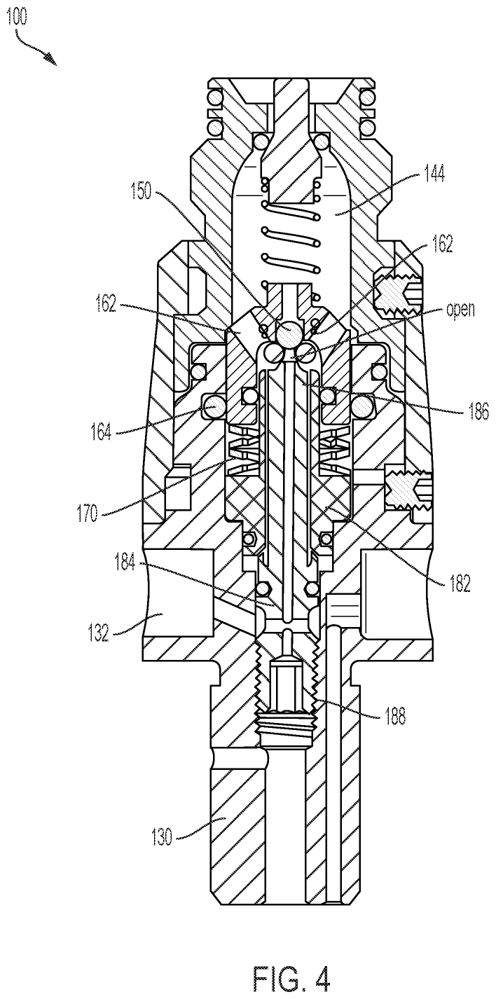

The spring stack 170 is compressed between the diaphragm 160 and the transfer tower assembly 180. In an alternative embodiment, the spring stack 170 is compressed between the diaphragm 160 and the base 130. Because the position of the transfer tower assembly 180 is unable to move relative to the bonnet 110 and base 130, the spring stack 170 imposes an expansion force on the diaphragm 160. Accordingly, when the gas in the outer chamber 144 is evacuated, for example, upon firing the marker, the pressure in the outer chamber 144 is reduced below the desired output pressure, which in an exemplary embodiment is between 400 and 3000 psi. The spring stack 170 forces the diaphragm 160, including the seat 150, to move (upward in FIG. 2) away from the opening of the gas transfer passageway 186. FIG. 4 illustrates a cross-sectional view of the regulator 100 in an open regulator position. There, the seat 150 is not in contact with the opening of the gas transfer passageway 186 at the top of the transfer tower assembly 180. Movement of the diaphragm 160 and its seat permits gas to transfer from the high-pressure tank through the one or more ports 162 of the diaphragm 160 and refill the outlet chamber 144. Once the gas filling the outlet chamber 144 reaches a predetermined pressure, the diaphragm 160 compresses the spring stack 170 and moves (downward in FIG. 4) to bring the seat 150 into contact with the opening of the gas transfer passageway 186, thereby closing off further gas from the tank as shown in FIG. 2. A shim ring 164 is provided to ensure smooth movement of the diaphragm 160. The cylindrical shape of the gas transfer tower assembly 170 aligns the diaphragm 160 along a central axis of the regulator 100.

In an exemplary embodiment of the invention, the spring stack 170 comprises one or more disc springs or Belleview washers. The number, size, and spring constant of the disc springs or washers can be varied to adjust the expansive force of the spring stack 170. The spring stack 170 may also comprise other springs, such as but not limited to wave springs or coil springs. The predetermined pressure within the outlet chamber 144 forces the seat 150 to close off the opening of the passageway 186. In addition, the length of the outer component 182 of the gas transfer tower assembly 180 can be varied to adjust the predetermined pressure.

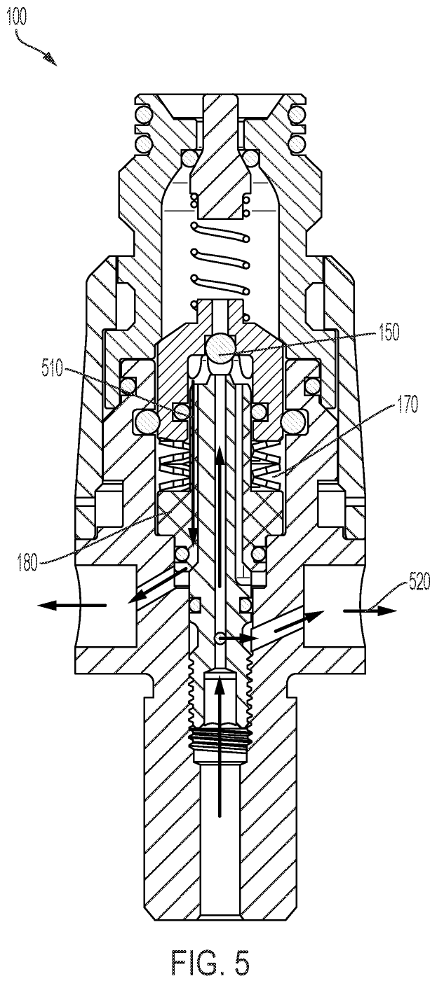

To be American Society for Testing and Materials (ASTM) International compliant, the gas regulator 100 comprises high and low-pressure burst discs as a safety measure in the unlikely event the regulator fails. As shown in FIG. 5, with the regulator 100 in an open regulator position, the transfer tower assembly 180 includes a low-pressure gas flow pathway 510, which couples the regulator to a low-pressure burst disk (not shown). The pathway 510 is unique to the present invention and allows the diaphragm 160 to function above the spring stack 170. The transfer tower assembly 180 further includes a high-pressure gas flow pathway 520, which taps into the high-pressure path to the seat 150.

The present invention advances gas regulators. By housing all components in a base and miniaturizing all parts of the regulator, among other novel features, the pressurized gas device becomes more portable, longer-lasting, and easier to maintain. The present invention's open airpath improves the components' longevity. In the case of a paintball marker, the spring stack and a tank pin attached to a diaphragm make for easier maintenance.

The invention has been described herein using specific embodiments for illustration only. However, it will be readily apparent to one of ordinary skill in the art that the invention's principles can be embodied in other ways. Therefore, the invention should not be regarded as limited in scope to the specific embodiments disclosed herein; it should be fully commensurate in scope with the following claims.

We claim:

1. A gas regulator comprising:
a base;
a gas transfer tower assembly comprising a high-pressure gas passageway having an opening at an end of the gas transfer tower assembly, wherein the gas transfer tower assembly is coupled to the base;
a diaphragm comprising a seat and one or more ports, wherein a portion of the diaphragm surrounds the end of the gas transfer tower assembly; and
a spring stack, wherein one end of the spring stack is in contact with the gas transfer tower assembly or the base, and an opposite end of the spring stack is in contact with the diaphragm.

2. The gas regulator of claim 1, wherein the end of the gas transfer tower assembly is cylindrically shaped.

3. The gas regulator of claim 1, wherein in a closed regulator position, the seat is in contact with the opening of the passageway.

4. The gas regulator of claim 4, wherein in an open regulator position, the seat is not in contact with the opening of the passageway.

5. The gas regulator of claim 1, wherein the passageway is in fluidic communication with a high-pressure gas source.

6. The gas regulator of claim 1, wherein the seat is ball-shaped.

7. The gas regulator of claim 1, wherein the seat is disposed on an interior surface of the diaphragm.

8. The gas regulator of claim 1, further comprising a rotatable bonnet.

9. The gas regulator of claim 1, wherein the gas transfer tower assembly comprises a burst disc passageway in fluidic communication with a burst disc.

10. A gas-operated device comprising the gas regulator of claim 1.

11. A method of regulating gas flow from a high-pressure gas source to a gas-operated device, the method comprising the steps of:
contacting a seat, disposed on an inner surface of a diaphragm, to an opening of a high-pressure gas passageway within a gas transfer tower assembly;
forcing the seat away from the opening of the high-pressure gas passageway;
transferring high-pressure gas from the opening of the high-pressure gas passageway to an outlet chamber; and
returning the seat in contact with the opening of the high-pressure gas passageway.

12. The method of claim 11, wherein the step of transferring high-pressure gas comprises transferring the high-pressure gas through one or more ports within the diaphragm.

13. The method of claim 11, wherein the step of forcing the seat away from the opening of the high-pressure gas passageway comprises exerting a spring force on the diaphragm.

14. The method of claim 13, further comprising the step of adjusting the spring force.

15. The method of claim 11, further comprising the step of securing a bonnet to the gas-operated device.

16. The method of claim 15, further comprising the step of rotating the bonnet.

17. The method of claim 11, wherein the high-pressure gas passageway is in fluidic communication with a high-pressure burst disk.

18. The method of claim 11, wherein the outlet chamber is in fluidic communication with a low-pressure burst disk via a low-pressure passageway within the transfer tower assembly.

19. The method of claim 11, wherein the transfer tower assembly is fixed to a base, and the step of forcing the seat away from the opening of the high-pressure gas passageway comprises moving the diaphragm relative to the transfer tower assembly.

20. The method of claim 19, wherein the diaphragm, seat, and transfer tower assembly are contained in the base.
